(19) United States
(12) Patent Application Publication
(10) Pub. No.: US 2025/0346153 A1
(43) Pub. Date: Nov. 13, 2025

(54) METHOD FOR CONTROLLING DUAL BATTERIES AND A VEHICLE CONTROLLING DUAL BATTERIES BY THE SAME

(71) Applicants: HYUNDAI MOTOR COMPANY, Seoul (KR); KIA CORPORATION, Seoul (KR)

(72) Inventor: Won Jae Lee, Hwaseong-si (KR)

(73) Assignees: HYUNDAI MOTOR COMPANY, Seoul (KR); KIA CORPORATION, Seoul (KR)

(21) Appl. No.: 18/970,566

(22) Filed: Dec. 5, 2024

(30) Foreign Application Priority Data
May 10, 2024 (KR) 10-2024-0061837

(51) Int. Cl. B60L 58/18; B60L 7/10

(52) U.S. Cl. CPC B60L 58/18; B60L 7/10; B60L 2240/54; B60L 2240/645

(57) ABSTRACT

A controlling method of a dual battery system for controlling a first battery and a second battery to supply power to a wheel driving motor in a vehicle includes: obtaining driving habit data of a driver for a discharging power of the driving motor or a charging power of the driving motor for one or more driving situations; determining at least one or more driving sections based on the one or more driving situations with respect to an expected driving route; determining an expected power based on the driving habit data with respect to each of the at least one or more driving sections; determining use plans of the first battery and the second battery based on an expected power corresponding to each of the at least one or more driving sections; and executing discharging or charging of the first battery and the second battery according to the use plans.

### CROSS-REFERENCE TO RELATED APPLICATION

The present application claims priority to Korean Patent Application No. 10-2024-0061837, filed on May 10, 2024, the entire contents of which are incorporated herein by this reference.

### TECHNICAL FIELD

The present disclosure relates to a method for controlling dual batteries and a vehicle controlling dual batteries by the same.

### BACKGROUND

In general, an electric vehicle, which is a type of mobility, is operated with wheels driven by the driving force of a driving motor.

Typically, a high-voltage battery is fixedly mounted in a vehicle to supply power to the driving motor.

The driving motor may be an AC motor, and an inverter may be included between the battery and the driving motor.

A charging status, which is a State of Charge (SOC), may indicate when charging is required. A battery of an electric vehicle may be charged by receiving external power through an onboard charger (OBC).

A charging time may be determined according to charging methods, including slow charging and fast charging.

With the continuous research and recent developments in batteries, the driving distance per one charging has greatly improved.

However, the battery fixedly mounted in an electric vehicle may not be sufficient, and thus an alternative is needed.

### SUMMARY

The present disclosure is provided to alleviate or solve the above-described conventional problems.

The present disclosure provides a new concept of technology that uses a second high-voltage battery added to or detached from the power system of an electric vehicle when necessary, in addition to a first high-voltage battery preset in the electric vehicle.

An embodiment of the present disclosure determines a use plan for a dual battery system based on driving habits of a driver, and performs conditioning control in advance to improve energy efficiency.

An embodiment of the present disclosure provides a method of controlling a first battery and a second battery for supplying power to a wheel driving motor placed in a vehicle. The method may include obtaining, by a controller, driving habit data of a driver related to a discharging power of the first battery and the second battery to supply to the driving motor or a charging power supplied to the first battery and the second battery by regenerated energy from the driving motor for one or more driving situations. The method may further include determining, by the controller, at least one or more driving sections based on the one or more driving situations for an expected driving route, and determining, by the controller, an expected power based on the driving habit data for each of the at least one or more driving sections. The method may further include determining, by the controller, use plans of the first battery and the second battery based on the corresponding expected power for each of the at least one or more driving sections, and executing, by the controller, discharging or charging of the first battery and the second battery according to the use plans.

The driving situations may be determined based on map data.

The at least one or more driving sections may include at least one of a city road section, a mountain road section, a highway section, a national road section, or a regenerative braking section.

The expected driving route may include a route to a destination based on map data.

Obtaining the driving habit data may include repeating for a predetermined number of times the obtaining of the driving data for each driving situation to determine an average power during a predetermined driving distance, and determining an average value by applying a standard normal distribution to data of the average power obtained by the repeating for the predetermined number of times.

Determining the use plans may include comparing the expected power corresponding to each of the at least one or more driving sections with a predetermined high-efficiency output power of a lower voltage battery between the first battery and the second battery.

Determining the use plans may further include determining to use the lower voltage battery in a section where the corresponding expected power is equal to or smaller than the output power among the at least one or more of sections, and determining to use another battery than the lower voltage battery in a section where the corresponding expected power is greater than the output power.

Executing the discharging or the charging may include, in response to a required power exceeding a maximum output of a currently used battery between the first battery and the second battery, supplying power to the wheel driving motor by using both the first battery and the second battery.

The method may further include executing a conditioning control on the first battery and the second battery according to the use plans.

Executing the conditioning control may include controlling to use a power of the second battery for conditioning the first battery and controlling to use a power of the first battery for conditioning the second battery.

According to an embodiment of the present disclosure, there is provided a vehicle, a plurality of wheels, a driving motor configured to drive at least one of the plurality of wheels, and a controller configured to control a first battery and a second battery for supplying power to the driving motor. The controller may include a memory for storing instructions and at least one processor for executing the instructions. The instructions, when executed by the at least one processor, may cause the controller to obtain driving habit data of a driver related to a discharging power or a charging power through the driving motor for one or more driving situation. The instructions, when executed by the at least one processor, may further cause the controller to determine at least one or more driving sections by dividing sections for an expected driving route by the one or more driving situations, and determine an expected power based on the driving habit data for each of the at least one or more driving sections. The instructions, when executed by the at least one processor, may further cause the controller to determine use plans of the first battery and the second battery based on the corresponding expected power for each of the at least one or more driving sections, and execute discharging or charging of the first battery and the second battery according to the use plans.

The first battery may be fixedly placed in the vehicle, and the second battery may be electrically, mechanically, and detachably connected to the vehicle.

The at least one or more driving sections may include a city road section, a mountain road section, a highway section, a national highway section, or a regenerative braking section.

The expected driving route may include a route to a destination based on map data.

Obtaining the driving habit data may include repeating for a predetermined number of times the obtaining the driving habit data for each driving situation to determine an average power during a predetermined driving distance, and determining an average value by applying a standard normal distribution to data of the average power obtained by the repeating for the predetermined number of times.

Determining the use plans may include comparing the expected power corresponding to each of the at least one or more driving sections with a predetermined high-efficiency output power of a lower voltage battery between the first battery and the second battery.

Determining the use plans may further include determining to use the lower voltage battery in a section where the corresponding expected power is equal to or smaller than the output power among the at least one or more driving sections, and determining to use another battery than the lower voltage battery in a section where the corresponding expected power is greater than the output power.

Executing the discharging or the charging may include, in response to a required power exceeding a maximum output of a currently used battery between the first battery and the second battery, supplying power to the driving motor by using both the first battery and the second battery.

The instructions may further cause the controller to perform a conditioning control on the first battery and the second battery according to the use plans.

Executing the conditioning control may comprise controlling to use a power of the second battery for conditioning the first battery, and controlling to use a power of the first battery for conditioning the second battery.

According to an embodiment of the present disclosure, a driving distance of an electric vehicle may be increased, and the usability thereof may be improved by detachably connecting a second high-voltage battery to a power system of an electric vehicle.

Battery efficiency improvement and an increased battery life may be ensured by effectively operating a dual battery system based on driving habits of a driver by trained driving environments.

Energy efficiency optimization may be ensured by individually operating dual batteries according to driving habits of the driver for each driving environment.

Conditioning consumption energy may be reduced on the dual battery system through individual conditioning control according to use plans.

Pre-conditioning allows immediate use of the high-efficiency range of the battery at the time of battery replacement.

The dual battery conditioning consumption energy may be minimized according to frequent driving point changes (e.g., driving by a driver with frequent acceleration and deceleration habits).

### BRIEF DESCRIPTION OF DRAWINGS

FIG. 1 is a view illustrating a power system of a first mobility according to an embodiment of the present disclosure;

FIG. 2 is a view illustrating a first mobility connected to a second mobility according to an embodiment of the present disclosure;

FIG. 3 is a view illustrating a control process of a dual battery system according to an embodiment of the present disclosure;

FIG. 4 is a view illustrating driving habit data by driving situations; and

FIG. 5 is a view illustrating a driving simulation according to an embodiment of the present disclosure.

### DETAILED DESCRIPTION

While embodiments of the present disclosure are described with reference to the accompanying drawings, it should be understood that various changes and modifications may be made in the present disclosure. Further, it should be understood that the present disclosure is not limited to the specific embodiments thereof, and various changes, equivalences, and substitutions may be made without departing from the scope and spirit of the present disclosure.

In the embodiments of the present disclosure, terms such as “module”, “unit”, “part”, and the like are terms used for nominal distinction between components, and it should not be interpreted as assuming that they are physically and chemically separated or capable of being separated or divided.

Terms containing ordinal numbers, such as “first”, “second”, and the like, may be used to describe various components, but the components are not limited by the terms. These terms may be used only in a nominal sense to differentiate one component from another component, and their mutual sequential meaning should be understood through the context of the corresponding description, not through such terms.

The term “and/or” is used to include all instances of any combination of multiple items being the subject. For example, “A and/or B” includes all three cases: “A”, “B”, and “A and B”.

When a component is described as being “coupled” or “connected” to another component, it should be understood that the component may be either connected directly to another component, or connected indirectly via another medium.

When a component, device, element, or the like of the present disclosure is described as having a purpose or performing an operation, function, or the like, the component, device, or element should be considered herein as being “configured to” meet that purpose or to perform that operation or function.

The terms in the present disclosure are used to describe example embodiment and are not intended to restrict and/or limit the present disclosure. Singular forms are intended to include plural forms unless the context clearly indicates otherwise. According to an embodiment of the present disclosure, terms such as “comprise” or “consist of” are used to designate presence of characteristics, numbers, steps, operations, elements, components or a combination thereof, and do not foreclose the presence or possibility of additional one or more other characteristics, numbers, steps, operations, elements, components or a combination thereof.

Unless otherwise defined, all terms used in the embodiments of the present disclosure including technical or scientific terms, have the same meaning as generally understood by a person having ordinary skill in the technical field to which the present disclosure pertains. Terms defined in commonly used dictionaries should be interpreted as having a meaning consistent with the meaning in the context of the related technology, and unless clearly defined in this application, should not be interpreted in an ideal or excessively formal sense.

In addition, the terms “unit”, “control unit”, “control device”, or “controller” are only widely used for names of devices that control the corresponding functions, and are not construed as being generic functional units. For example, devices using the terms may include a communication device that communicates with another controller or sensor to control the corresponding function, a computer-readable recording media that stores operating systems, logic commands, input/output information, and the like, and at least one or more of processor that performs determination, calculation, decision, and the like used to control the corresponding function.

A processor may include a semiconductor integrated circuit and/or electronic elements that perform at least one or more of comparison, determination, calculation, and decision to achieve a programmed function. For example, the processor may be one or the combination of a computer, a microprocessor, a CPU, an ASIC, and electronic circuits (circuitry, logic circuits).

A computer-readable recording medium (or referred to as memory) includes all types of storage devices that store data that is read by a computer system. Examples of the computer-readable recording medium may include at least one a memory of flash memory type, hard disk type, micro type, and card type (e.g. Secure Digital Card (SD Card) or eXtream Digital Card (XD Card)), and a memory of Random Access Memory (RAM), Static RAM (SRAM), Read-Only Memory (ROM), Programmable ROM (PROM), Electrically Erasable PROM (EEPROM), and magnetic RAM (MRAM), a magnetic disk, and an optical disk type.

Such recording medium may be electrically connected to the processor, and the processor may load and record data from the recording medium. The recording medium and processor may be integrated or may be physically separated.

An embodiment of the present disclosure is explained below with reference to the drawings.

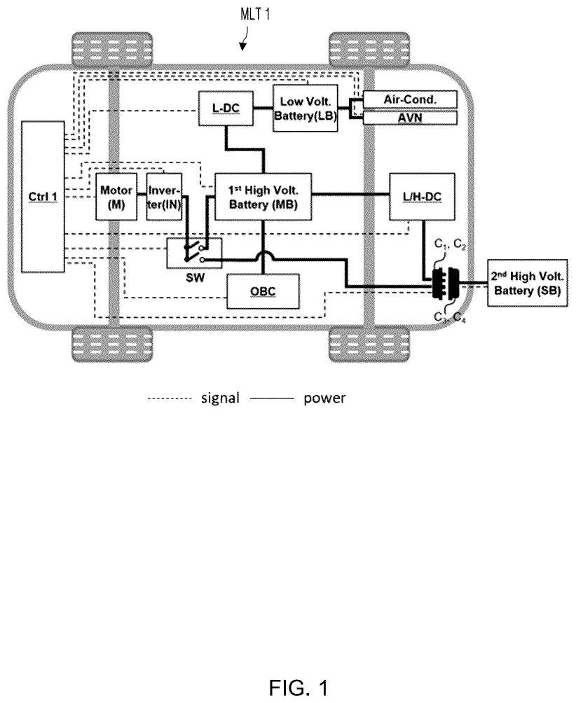

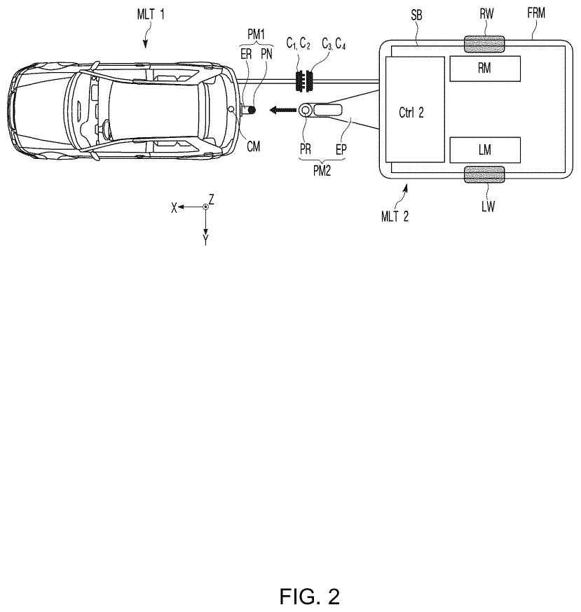

FIG. 1 is a schematic view illustrating a power system of a first mobility MLT 1 (e.g., an electric vehicle), and FIG. 2 is a view illustrating that a second mobility MLT 2 (e.g., a trailer) is connected to the first mobility MLT 1.

Referring to FIGS. 1 and 2, the respective structures of the first mobility MLT 1 and the second mobility MLT 2 are described according to an embodiment. As used throughout this disclosure, the term “mobility” is intended to mean any moving vehicle, device, machine, instrument, apparatus, or the like.

Referring to FIG. 1, the first mobility MLT 1 according to an embodiment may be, for example, an electric vehicle, including a first driving motor M, an inverter IN, a first high-voltage battery MB, an on-board charger OBC, a first DC/DC converter L-DC, a low-voltage battery LB, an air conditioning equipment Air-Cond that operates at a low-voltage, an Audio Video Navigation AVN, a second DC/DC converter L/H-DC, a switch SW, and a controller (referred to as a first controller) Ctrl 1.

The first driving motor M may provide a driving force to the wheels of the vehicle, and the first driving motor M may be an alternating current motor.

The inverter IN may invert a direct current power supplied to the first driving motor M to an alternating current.

The first high-voltage battery MB may be fixedly provided in the body of the first mobility MLT 1, for example, under the bottom of a vehicle cabin.

The first high-voltage battery MB may mainly supply electric power to the first driving motor M, and may be charged with the onboard charger OBC.

The first high-voltage battery MB may be connected to the low-voltage battery LB through the first DC/DC converter L-DC to charge the low-voltage battery LB.

The first DC/DC converter L-DC may be a step-down DC/DC converter (LDC; low-voltage DC-DC converter) to charge the low-voltage battery LB.

The low-voltage battery LB may be, for example, a battery of 12V or 24V, and may supply electric power to electric devices in the vehicle, such as the air conditioning equipment Air-Cond., the AVN, and the like, that operate at a low voltage.

The second high-voltage battery SB in FIG. 1 may be provided in the second mobility MLT 2 and mechanically connected through the connection mechanism described below, but the present disclosure is not limited thereto. For example, the second high-voltage battery SB may be mechanically connected as being detachably placed in the first mobility.

The second high-voltage battery SB may be electrically connected via a wire (or wirelessly in certain ranges, if possible) to the vehicle power system, including the first high-voltage battery MB as an additional battery, in a way that the second high-voltage battery SB may not affect the operation of the power system (power supply to vehicle electronics, a driving motor, and the like).

The second high-voltage battery SB may be a replaceable battery, an auxiliary battery, an extended battery, or a secondary battery, but this is only for distinction from the first high-voltage battery MB. The second high-voltage battery SB may not be limited by the name with functions, characteristics, relationships with other objects (the first high-voltage battery MB, a host vehicle, and the like), or its own mechanical/electrical/chemical structure, battery type (types of packaging method, anode material/cathode material/separator material, and the like), charging method, and the like.

The second high-voltage battery SB may be connected via a wire or wirelessly with the first controller Ctrl 1 of the first mobility MLT 1, or a battery management system (BMS) of the first high-voltage battery MB. Various sensing information (e.g., voltage, current, temperature, and the like) related to the SoC state, physical/electrical/chemical status of the second high-voltage battery SB may be transmitted to the first controller Ctrl 1. However, the present disclosure is not limited thereto, for example, the information on the second high-voltage battery SB may be transmitted to the first controller Ctrl 1 through a second controller Ctrl 2 of the second mobility MLT 2.

According to an embodiment, a high-voltage battery applied to the first high-voltage battery MB and the second high-voltage battery SB may include, for example, a plurality of battery cells (not shown) that output a voltage of 2.7 to 4.2 V. The plurality of battery cells may be connected in series/parallel to each other in a preset number to form a single module. The high-voltage battery may be packaged in one battery package with one or more battery modules connected in series/parallel to output a desired output voltage, for example, approximately 400 V, 800 V, or several kV.

The first high-voltage battery MB and the second high-voltage battery SB each may include the battery management system (BMS).

The BMS may include a battery management unit (BMU), a cell monitoring unit (CMU), and a battery junction box (BJB).

The BMS may perform a cell balancing function to ensure the performance of the entire battery pack by constantly maintaining the voltage of each cell, a State of Charge (SoC) function to calculate the capacity of the entire battery system, battery cooling, charging, discharging control, and the like.

The BMU may receive information on all cells from the CMU and perform the functions of the BMS based on the information.

The BMU may consist of, for example, two (2) micro-control units MCU, and each MCU may include a single controller area network (CAN) communication port. The MCU may include a CAN interface to communicate with a vehicle controller which is the upper-level device of the BMS, and a CAN interface for collecting the information of the CMU which is the lower-level device.

The CMU may be directly attached to a battery cell to perform sensing of voltage, current, temperature, and the like. The CMU may not perform calculations related to BMS algorithms but may perform sensing. A plurality of battery cells may be connected to a single CMU, and information on each cell may be transmitted to the BMU through the CAN interface.

The BJB may be a pack-level detection mechanism of the BMS and a connection medium between a high-voltage battery and a drivetrain. The BJB may measure and record a battery voltage and a current flowing inside and outside the battery to accurately calculate the SoC. The BJB may perform important functions for safety such as overcurrent detection, insulating monitoring, and the like.

The second high-voltage battery SB may be a high-voltage battery lower than the first high-voltage battery MB, and the second DC/DC converter L/H-DC may be a step-up DC/DC converter. The second high-voltage battery SB may be a high-voltage battery higher than the first high-voltage battery MB, and the second DC/DC converter L/H-DC may be a step-down DC/DC converter. According to an embodiment, the second DC/DC converter L/H-DC may be bidirectional. Therefore, the first high-voltage battery MB and the second high-voltage battery SB may charge and discharge each other.

According to an embodiment, the second DC/DC converter L/H-DC may be built in the first mobility MLT 1 in the power system, but the present disclosure is not limited thereto. For example, unlike an embodiment of the present disclosure, the second DC/DC converter L/H-DC may be provided as a separate component and additionally and detachably connected to the power system. The second DC/DC converter L/H-DC may be built in or detachably placed in the second mobility MLT 2.

According to an embodiment of the present disclosure, the second DC/DC converter L/H-DC may not be included. In this case, the first high-voltage battery MB and the second high-voltage battery SB may not charge and discharge each other.

For the detachable electrical connection of the second high-voltage battery SB to the power system, the power system of the first mobility MLT 1 may include first and second connectors C1 and C2, and the second high-voltage battery SB may include third and fourth connectors C3 and C4.

For example, the first and second connectors C1 and C2 may be connectors in an integrated form, and the third and fourth connectors C3 and C4 also may be connectors in an integrated form.

The first connector C1 may be connected to the second DC/DC converter L/H-DC, and the second connector C2 may be connected to the switch SW.

Although not shown, a signal transmission connector may be added to transmit sensing and status information on the second high-voltage battery SB to the controller.

The switch SW may be fixedly and electrically connected to the inverter IN, and switched between the first high-voltage battery MB and the second connector C2 to connect the first high-voltage battery MB to the inverter IN or electrically connect the inverter IN to the second high-voltage battery SB.

The first controller Ctrl 1 may be a vehicle controller of the highest level to control all electrical devices in the first mobility MLT 1, but the present disclosure is not limited thereto. For example, the first controller Ctrl 1 in FIG. 1 may be a power controller of the lower level from the vehicle controller.

According to an embodiment, the first controller Ctrl 1 may include a computer-readable recording medium that stores an operating system, logic commands, input/output information, and the like, and one or more processors that read the information to perform judgments, calculations, decisions, and the like.

The second high-voltage battery SB in FIG. 1 may be provided in the second mobility MLT 2 as shown in FIG. 2.

The second mobility MLT 2 according to an embodiment may be, for example, a trailer, and may include a frame FRM, a second left-wheel LW placed on the left of the frame FRM, a second right-wheel RW placed on the right of the frame FRM, a second left-driving motor LM for providing a driving force to the second left-wheel LW, a second right-driving motor RM for providing a driving force to the second right-wheel RW, and a second controller Ctrl 2.

The second high-voltage battery SB may be fixedly provided in the second mobility MLT 2, but the present disclosure is not limited thereto. The second high-voltage battery SB may be detachably placed in the second mobility MLT 2. The second high-voltage battery SB mounted in the frame FRM with a fully-discharged SoC status may be removed, and replaced with a new second high-voltage battery SB with a full-charged SoC status.

When the second high-voltage battery SB is fixedly mounted in the second mobility MLT 2, the second mobility MLT 2 may include a charging connector for charging the second high-voltage battery SB.

The frame FRM may form the exterior of the second mobility MLT 2 and accommodate other components.

The frame FRM may include a second pivot mechanism PM2 as a second connection mechanism. The second pivot mechanism PM2 may be detachably pivot-connected to a first pivot mechanism PM1, which is a first connection mechanism fixed to the body of the first mobility MLT1.

The first pivot mechanism PM1 may include an extension rod ER extending from the body of the first mobility MLT 1 rearwardly, and a pivot pin PN upwardly protruding from the end of the extension rod ER.

The second pivot mechanism PM2 may include an extension unit EP in a triangle shape, which is straightforwardly protruding from the frame FRM of the second mobility MLT 2, and a pivot ring PR into which the pivot pin PN is rotatably inserted from the end of the extension unit EP.

The pivot pin PN may be limited in linear movement while being inserted into the pivot ring PR, but may rotate with respect to a Z-axis direction in FIG. 2. Therefore, while being pivot-connected, the second mobility MLT 2 may be limited in linear movement with regard to the first mobility MLT 1 based on the pivot connection point, but may rotate with respect to the z-axis.

When driving in the forward direction, i.e., in the X-axis direction, the first mobility MLT 1 and the second MLT 2 may maintain straight driving without separate steering control for the second mobility MLT 2.

An embodiment of the present disclosure may include a pivot mechanism as first and second connection mechanisms, but the present disclosure is not limited thereto. For example, the first and second mechanisms may be known mechanisms that implements a non-rotational connection with respect to the Z-axis.

The second left-driving motor LM may include a rotational axis connected to the second left-wheel LW to provide a driving force to the second left-wheel LW.

The second right-driving motor RM may include a rotational axis connected to the second right-wheel RW to provide a driving force to the second right-wheel RW.

The second left-wheel LW and the second right-wheel RW may be respectively connected to the second left-driving motor LM and the second right-driving motor RM, thereby enabling independent driving from each other.

The second left-driving motor LM and the second right-driving motor RM may drive in the forward direction and in the reverse direction, respectively. When driven in the forward direction, the second mobility MLT 2 may travel in the forward direction, and when driven in the reverse direction, the second mobility MLT 2 may travel in the rear direction.

For example, the second left-driving motor LM and the second right-driving motor RM each may be implemented in an in-wheel driving system where each driving motor is provided in wheels, but the present disclosure is not limited thereto.

Unlike an embodiment, the second mobility MLT 2 may not operate independently on the left and right, but the driving force of a single common motor may be delivered into the second left-wheel LW and the second right-wheel RW. For this, a vehicle gear may be included between the common second driving motor, the second left-wheel LW, and the second right-wheel RW. The driving force of the second driving motor may be divided by the vehicle gear and transmitted to the second left-wheel LW and the second right-wheel RW. A torque vectoring means (i.e., torque vectoring differential) may be added for torque distribution between the second left-wheel LW and the second right-wheel RW.

Referring to FIG. 2, the second controller Ctrl 2 may control the second left-driving motor LM and the second right-driving motor RM to achieve forward driving and reverse driving of the second mobility MLT 2. The second controller Ctrl2, when the steering of the second mobility MLT 2 is needed, may change the driving direction of the second mobility MLT 2 by controlling respective toques or the rotation numbers of the second left-driving motor LM and the second right-driving motor RM. Through the independent control of driving of the second left-driving motor LM and the second right-driving motor RM, the steering of the second mobility MLT2 may be ensured without a separate steering device.

Wired and wireless communication means may be included to deliver information between connectors in FIG. 1, the first mobility MLT 1, and the second mobility MLT 2.

According to an embodiment of the present disclosure, the first controller Ctrl 1 or the second controller Ctrl 2 may include a memory and a processor. The memory may store computer commanders for performing the functions of the controller, and the processor may perform the functions by loading and executing the commands from the memory.

The memory may include at least one of hard disk drive (HDD), solid-state drive (SDD), silicon disk drive (SDD), ROM, RAM, CD-ROM, magnetic tape, floppy disk, and optical data storage device.

The processor may include at least one of a computer, a microprocessor, a central processing unit (CPU), an ASIC, an electric circuit, and a logic circuit.

The first connector C1 and the second connector C2 of the first mobility MLT1 may be connected to the third connector C3 and the fourth connector C4 of the second mobility MLT2. As a signal transmission connector is connected, the first mobility MLT 1 and the second mobility MLT 2, i.e., the first controller Ctrl 1 and the second controller Ctrl2, may communicate with each other.

When the first mobility MLT 1 and the second mobility MLT 2 are mechanically and electrically connected, and the first mobility MLT 1 starts the forward driving, the second controller Ctrl 2 may perform the straightforward driving of the second mobility MLT 2 by controlling the second left-driving motor LM and the second right-driving motor RM according to the signal received from the first connector C1.

Part or all of the speed, gear position, steering angle, accelerator pedal sensor (APS) information, and brake pedal sensor (BPS) information of the first mobility MLT 1 may be transmitted to the second mobility MLT 2.

The second controller Ctrl 2 of the second mobility MLT 2 may determine whether the first mobility MLT 1 operates in the forward direction or in the reverse direction by using part or all of the speed, the gear position, the APS information, and the BPS information of the first mobility MLT 1. However, the present disclosure is not limited thereto, for example, it may be possible to directly receive information on whether the first mobility MLT 1 operates in the forward direction or in the reverse direction from the first controller Ctrl 1.

When the first mobility MLT 1 operates in the forward direction, the second controller Ctrl 2 may drive the second left-driving motor LM and the second right-driving motor RM in the forward direction to allow the second mobility MLT 2 to operate in the straightforward direction. When the first mobility MLT 1 operates in the reverse direction, the second controller Ctrl 2 may operate the second left-driving motor LM and the second right-driving motor RM in the reverse direction to allow the rear-driving of the second mobility MLT2.

The second controller Ctrl 2 may determine the steering status based on steering angle information on the first mobility MLT 1 and perform the steering of the second mobility MLT 2 accordingly.

The second mobility MLT 2 may not include a separate steering device such as a steering wheel, a steering rack, and the like, but may perform the steering through torque control of the second left-driving motor LM and second right-driving motor RM.

The second controller Ctrl 2 may calculate a driving torque for driving and a steering torque for steering for each of the second left-driving motor LM and the second right-driving motor RM to use for control.

For example, for the steering of the second mobility MLT 2, the steering torque value of the second left-driving motor LM and the second right-driving motor RM according to the steering angle of the first mobility MLT 1 may be included in a look-up table or a calculation program.

While driving in a straightforward direction, the speed of the second mobility MLT 2 may be controlled not to exceed the speed of the first mobility MLT 1. The pivot connection between the first mobility MLT 1 and the second mobility MLT 2 may be within a predetermined pivot angle. For example, while driving in the straightforward direction, when the speed of the second mobility MLT 2 is equal to or smaller than the speed of the first mobility MLT 1, the pivot angle of the second mobility MLT 2 with respect to the first mobility MLT 1 from the pivot connection point may be 0 degrees (an angle at which the first mobility MLT 1 and the second mobility MLT 2 are aligned).

While driving in the forward direction, the second mobility MLT 2 may be controlled to follow the first mobility MLT 1, thereby achieving continued and smooth driving of a plurality of mobilities.

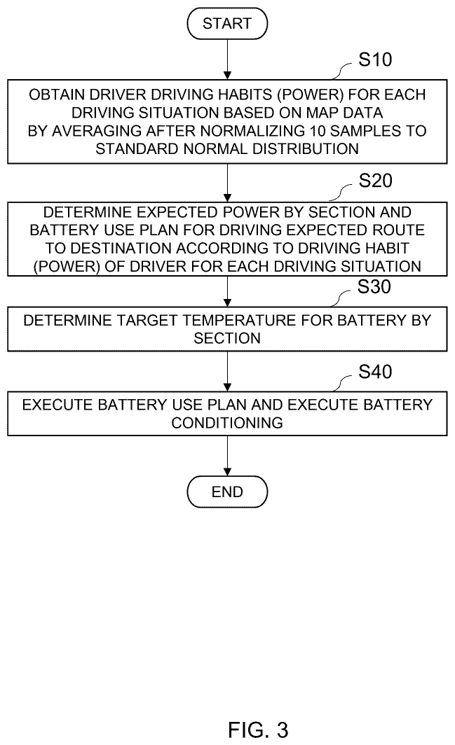

FIG. 3 is a flow chart illustrating a battery control process according to an embodiment of the present disclosure, and the description thereof is detailed below.

According to an embodiment, the battery control process may be performed under the control of the first controller Ctrl 1, but the present disclosure is not limited thereto.

The first controller Ctrl 1 may include a memory and a processor. The memory may store computer programs for the battery control process according to an embodiment, and when necessary, various data required for the control process. The processor may execute the programs stored in the memory, and the first controller Ctrl 1 may perform the battery control process according to the executed programs.

Referring to FIG. 3, at step S10, the first controller Ctrl 1 may obtain driving habits of a driver for each driving situation based on map data.

The map data may be, for example, map data for the navigation of an AVN, but the present disclosure is not limited thereto.

For example, the driving situation may be based on the road type included in the map data.

For example, the driving situation may be distinguished according to a type of road, driving, or travel section, such as a city road section, a mountain up-hill section, a mountain down-hill section, a highway section, a national highway section, and a regenerative braking section, based on map data.

The city road section may include a road section defined by a city road in the road information of the map data, and the mountain section may include a road section defined by a mountain road in the road information of the map data. Each of the highway section and the national highway section may include a road section defined by a highway and a national highway of the map data.

The regenerative braking may be performed according to the regenerative braking condition set during the driving, and the section where the regenerative braking is performed may be defined as a regenerative braking section.

For example, the regenerative braking conditions may include a decelerating speed, a driving distance to a target speed, a driving time, a battery SoC state, and the like, but the present disclosure is not limited thereto.

In an embodiment, the data on the driving habits of the driver for each driving situation may be obtained through training.

While a vehicle drives the driving distance set by a driving situation, the supply power to the driving motor M by the required output of the driver, i.e., discharging power data of the battery (the first high-voltage battery MB or the second high-voltage battery SB) may be obtained in real-time. An average discharging power in the driving distance may also be determined, and average discharging power data may be obtained by repeating the above a predetermined number of times.

An average value based on probability weighting may be determined by applying a standard normal distribution to the obtained average discharging power data to determine the average discharging power for the corresponding driving situation.

It is understood that the desired output of the driver may be determined based on, for example, an Accelerator Position Sensor (APS) signal.

In the same manner, the average charging power during the driving distance may be determined by obtaining the regenerative braking power based on the deceleration request from the driver, i.e., the regenerative braking charging power data to the battery in real-time while the vehicle drives a set driving distance for each driving situation to obtain the average charging power data by repeating the above a predetermined number of times.

Similarly, the average value by probability weighting may be determined by applying a standard normal distribution to the obtained average charging power data to determine the average charging power for the corresponding driving situation.

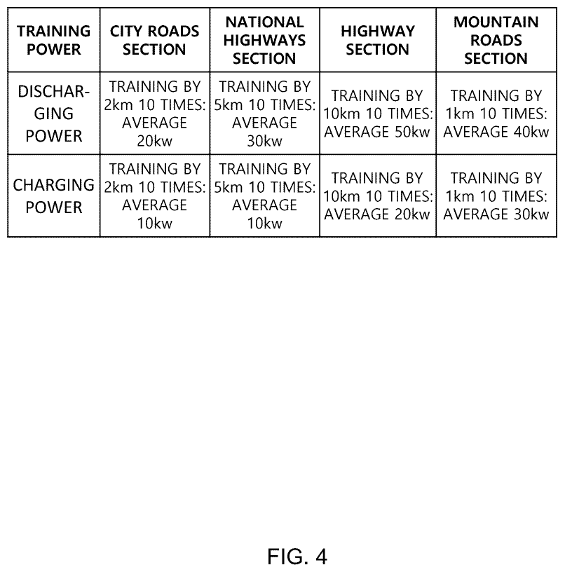

FIG. 4 is a view illustrating that average power is obtained through training for each driving situation, and the description thereof is detailed below.

The standard normal distribution may be applied to the discharging power obtained by driving 2 km each for 10 times on the city road section to obtain the average discharging power of 20 kW.

The standard normal distribution may be applied to the charging power obtained by driving 2 km each for 10 times on the city road section to obtain the average charging power of 10 kW.

In the national highway section, the average discharging power of 30 kW may be obtained by applying the standard normal distribution to the discharging power obtained by driving 5 km each for 10 times on the national highway section, and the average charging power of 10 kW may be obtained by applying the standard normal distribution to the charging power obtained by driving 5 km each for 10 times on the national highway section.

In the highway section, the average discharging power of 50 kW may be obtained by applying the standard normal distribution to the discharging power obtained by driving 10 km each for 10 times on the highway section, and the average charging power of 20 kW may be obtained by applying the standard normal distribution to the charging power obtained by driving 10 km each for 10 times on the highway section.

In the mountain road section, the average discharging power of 40 kW may be obtained by applying the standard normal distribution to the discharging power obtained by driving 1 km each for 10 times on the mountain road section, and the average charging power of 30 kW may be obtained by applying the standard normal distribution to the charging power obtained by driving 1 km each for 10 times on the mountain road section.

It is understood that driving habit data for each driving situation may be continuously updated by continuously accumulating data for each situation.

Referring back to FIG. 3, at step S20, the first controller Ctrl 1 may determine at least one or more sections (i.e., driving, road, or travel sections) according to driving habit data for each driving situation with respect to the expected driving route. The first controller Ctrl 1 may also determine the expected power and the battery use plan for each section.

For example, the expected driving route may be determined based on the route from the current location to the destination as the destination is input to the navigation of the AVN.

The expected driving route may include at least one of the city road section, the mountain road section, the highway section, the national highway section, the regenerative braking section, and the like based on the driving situation.

The first controller Ctrl 1 may determine the expected power (charging or discharging power) by section based on driving habit data for each driving situation.

The first controller Ctrl 1 may determine which battery is used between the first high-voltage battery MB and a second high-voltage battery SB in each section.

The battery used in each section may be determined based on the expected power in the corresponding section and the output power of the maximum efficiency of the lower voltage battery between the first high-voltage battery MB and the second high-voltage battery SB.

In an embodiment, the first high-voltage battery MB is a lower voltage battery than the second high-voltage battery SB, but the present disclosure is not limited thereto.

The expected power in each section and the maximum efficiency output power (setting power) of the first high-voltage battery MB may be compared to each other to determine which battery to use in each section.

As a result of the comparison, the first high-voltage battery MB may be used in the expected power section below the maximum efficiency output power, and the second high-voltage battery SB may be used in other sections.

At step S30, the first controller Ctrl 1 may determine a target temperature of the battery by section to perform battery conditioning.

Optimal temperature data for each battery state (e.g., SoH, SoC, voltage, and the like) may be stored in the memory in advance.

The data may be obtained through experiments.

The optimal temperature data may be secured according to battery characteristics. For example, the optimal temperature data may be secured according to characteristics (or specifications) such as C-rate, nominal voltage, efficiency, maximum current, system voltage, and continuous output (power) of the battery.

The battery characteristics of the first high-voltage battery MB may be different from that of the second high-voltage battery SB. Therefore, the target temperature for the section where the first high-voltage battery MB is used may be determined based on the temperature data of characteristics on the first high-voltage battery MB or the battery closest to the first high-voltage battery MB. The target temperature for the section where the second high-voltage battery SB is used may be determined in the same manner.

At step S40, the first controller Ctrl 1 may execute charging or discharging of the first high-voltage battery MB and the second high-voltage battery SB according to the battery use plan.

The first controller Ctrl 1 may perform the conditioning control of the first high-voltage battery MB and the second high-voltage battery SB according to the battery use plan and the target temperature in each section.

The conditioning control may include heating the battery with an electric heater to increase the temperature to a target temperature.

The execution of the conditioning control may be achieved by using the power of the remaining batteries in the prior section before the battery is used.

For example, the conditioning control of the second high-voltage battery SB to be used in the next section may be performed by using the power of the first high-voltage battery MB in the section where the first high-voltage battery MB is to be used.

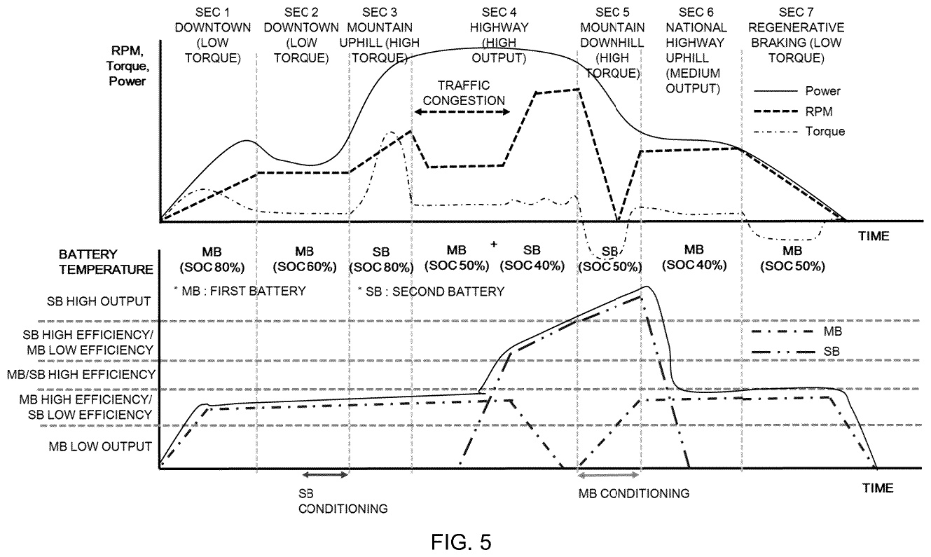

FIG. 5 is a view illustrating a driving simulation according to an embodiment. The description thereof is detailed below.

The graph on the upper side in FIG. 5 may indicate the number of rotations (RPM) and the torque of the driving motor, and the discharging and charging power of the first high-voltage battery MB or the second high-voltage battery SB in each of section 1 to section 7 in the expected driving route.

Section 1 to section 7 may be distinguished according to the criteria for the driving situations based on the map data as described above.

In FIG. 5, sections 1 and 2 may be low-power city road sections, section 3 may be a high-power acceleration section (e.g., a mountain road uphill section), section 4 may be a high-power highway section, section 5 may be a regenerative braking section as a high-power regenerative power deceleration section (e.g., a mountain road downhill section), section 6 may be a low-power national highway section, and section 7 may be a low-power regenerative power regenerative braking section.

The batteries used in sections 1, 2, 6, and 7 may be the first high-voltage battery MB, which is a lower-voltage battery, and the battery used in sections 3 and 5 may be the second high-voltage battery SB. In section 4, the first high-voltage battery MB may be determined to be used, but it may be difficult to satisfy the required output of the driver with the first high-voltage battery MB alone so that the second high-voltage battery SB may be used together with the first high-voltage battery MB.

As the battery is used according to the use plan, the SoC of the first high-voltage battery MB may be reduced to 80% in section 1, 60% in section 2, 50% in section 4, 40% in section 6, and the like, and charged by the regenerative braking power and recovered to 50% in section 7.

The SoC of the second high-voltage battery SB may be 80% in section 3, may be decreased to 40% in section 4, and charged and recovered to 50% in section 5.

As it is determined that the second high-voltage battery SB is used in section 3, the preconditioning of the second high-voltage battery SB may be performed by using the power of the first high-voltage battery MB in section 2.

In the same manner, as it is determined that the first high-voltage battery MB is used in section 6, the preconditioning of the first high-voltage battery MB may be performed by using the power of the second high-voltage battery SB in section 5.

The graph on the lower side of FIG. 5 illustrates the battery temperatures during driving from section 1 to section 7. When it is assumed that the temperature is ensured through conditioning control, according to an embodiment of the present disclosure, since the battery use plan is different by driving situation, the energy required for battery conditioning may correspond to the area represented by solid lines.

However, unlike an embodiment of the present disclosure, according to a comparative example, when the battery use is not planned, the conditioning control on the first high-voltage battery MB and the second high-voltage battery SB may be performed in the same state, and thus the consumed energy may correspond to twice the solid line area.

Therefore, according to an embodiment, the battery conditioning may be efficiently performed, thereby reducing energy consumption.

What is claimed is:

1. A method of controlling a first battery and a second battery for supplying power to a wheel driving motor placed in a vehicle, the method comprising:
obtaining, by a controller, driving habit data of a driver related to a discharging power of the first battery or the second battery to supply to the driving motor or a charging power supplied to the first battery or the second battery by regenerated energy from the driving motor for one or more driving situations;
determining, by the controller, at least one or more driving sections based on the one or more driving situations for an expected driving route;
determining, by the controller, an expected power based on the driving habit data for each of the at least one or more driving sections;
determining, by the controller, use plans of the first battery and the second battery based on the corresponding expected power for each of the at least one or more driving sections; and
executing, by the controller, discharging or charging of the first battery and the second battery according to the use plans.

2. The method as claimed in claim 1, wherein the one or more driving situations are determined based on map data.

3. The method as claimed in claim 1, wherein the at least one or more driving sections include at least one of a city road section, a mountain road section, a highway section, a national highway section, or a regenerative braking section.

4. The method as claimed in claim 1, wherein the expected driving route includes a route to a destination based on map data.

5. The method as claimed in claim 1, wherein obtaining the driving habit data comprises:
repeating for a predetermined number of times the obtaining of the driving habit data for each driving situation to determine an average power during a predetermined driving distance; and
determining an average value by applying a standard normal distribution to data of the average power obtained by the repeating for the predetermined number of times.

6. The method as claimed in claim 1, wherein determining the use plans comprises comparing the expected power corresponding to each of the at least one or more driving sections with a predetermined high-efficiency output power of a lower voltage battery between the first battery and the second battery.

7. The method as claimed in claim 6, wherein determining the use plans further comprises:
determining to use the lower voltage battery in a section where the corresponding expected power is equal to or smaller than the output power among the at least one or more driving sections; and
determining to use another battery than the lower voltage battery in a section where the corresponding expected power is greater than the output power.

8. The method as claimed in claim 1, wherein executing the discharging or the charging comprises, in response to a required power exceeding a maximum output of a currently used battery between the first battery and the second battery, supplying power to the wheel driving motor by using both the first battery and the second battery.

9. The method as claimed in claim 1, further comprising executing a conditioning control on the first battery and the second battery according to the use plans.

10. The method as claimed in claim 9, wherein executing the conditioning control comprises controlling to use a power of the second battery for conditioning the first battery, and controlling to use a power of the first battery for conditioning the second battery.

11. A vehicle, comprising:
a plurality of wheels;
a driving motor configured to drive at least one of the plurality of wheels; and
a controller configured to control a first battery and a second battery for supplying power to the driving motor,
wherein the controller includes a memory for storing instructions and at least one processor for executing the instructions, and
wherein the instructions, when executed by the at least one processor, cause the controller to
obtain driving habit data of a driver related to a discharging power of the first battery or the second battery to supply to the driving motor, or a charging power supplied to the first battery or the second battery by regenerated energy from the driving motor for one or more driving situations,
determine at least one or more driving sections by dividing sections for an expected driving route by the one or more driving situations,
determine an expected power based on the driving habit data for each of the at least one or more driving sections,
determine use plans of the first battery and the second battery based on the corresponding expected power for each of the at least one or more driving sections, and
execute discharging or charging of the first battery and the second battery according to the use plans.

12. The vehicle as claimed in claim 11, wherein the first battery is fixedly placed in the vehicle, and the second battery is electrically, mechanically, and detachably connected to the vehicle.

13. The vehicle as claimed in claim 11, wherein the at least one or more driving sections include a city road section, a mountain road section, a highway section, a national highway section, or a regenerative braking section.

14. The vehicle as claimed in claim 11, wherein the expected driving route includes a route to a destination based on map data.

15. The vehicle as claimed in claim 11, wherein obtaining the driving habit data comprises:
repeating for a predetermined number of times the obtaining the driving habit data for each driving situation to determine an average power during a predetermined driving distance; and
determining an average value by applying a standard normal distribution to data of the average power obtained by the repeating for the predetermined number of times.

16. The vehicle as claimed in claim 11, wherein determining the use plans comprises comparing the expected power corresponding to each of the at least one or more driving sections with a predetermined high-efficiency output power of a lower voltage battery between the first battery and the second battery.

17. The vehicle as claimed in claim 16, wherein determining the use plans further comprises;
determining to use the lower voltage battery in a section where the corresponding expected power is equal to or smaller than the output power among the at least one or more driving sections; and
determining to use another battery than the lower voltage battery in a section where the corresponding expected power is greater than the output power.

18. The vehicle as claimed in claim 11, wherein executing the discharging or the charging comprises, in response to a required power exceeding a maximum output of a currently used battery between the first battery and the second battery, supplying power to the driving motor by using both the first battery and the second battery.

19. The vehicle as claimed in claim 11, wherein the instructions further cause the controller to perform a conditioning control on the first battery and the second battery according to the use plans.

20. The vehicle as claimed in claim 19, wherein executing the conditioning control comprises controlling to use a power of the second battery for conditioning the first battery, and controlling to use a power of the first battery for conditioning the second battery.
